(19) United States
(12) Patent Application Publication
(10) Pub. No.: US 2020/0001581 A1
(43) Pub. Date: Jan. 2, 2020

(54) LAMINATED FILM AND METHOD OF MANUFACTURING THE SAME, POLYMER FILM AND METHOD OF MANUFACTURING THE SAME, AND ROLL

(71) Applicant: FUJIFILM CORPORATION, Tokyo (JP)

(72) Inventor: Takeaki SAWAYA, Fujinomiya-shi (JP)

(21) Appl. No.: 16/566,915

(22) Filed: Sep. 11, 2019

Related U.S. Application Data
(63) Continuation of application No. PCT/JP2018/008173, filed on Mar. 2, 2018.

(30) Foreign Application Priority Data
Mar. 29, 2017 (JP) 2017-066078

(51) Int. Cl. B32B 27/08; B32B 7/027; B32B 27/36; B32B 27/30; B32B 27/32; B32B 37/15

(52) U.S. Cl. CPC B32B 27/08; B32B 7/027; B32B 27/36; B32B 27/306; B32B 2535/00; B32B 37/153; B32B 2250/24; B32B 2250/03; B32B 27/32

(57) ABSTRACT

A laminated film having, in order: a layer containing a thermoplastic polymer A with a thickness of 5 nm to 1,000 nm; a layer containing a water-soluble thermoplastic polymer B; and a layer containing a thermoplastic polymer C, the layers being adjacent to each other, in which the layer containing the thermoplastic polymer A contains no organic solvent, or an organic solvent content in the layer containing the thermoplastic polymer A is greater than 0 mass % and less than 0.01 mass % with respect to a total mass of the layer containing the thermoplastic polymer A and a method of manufacturing the laminated film, a polymer film and a method of manufacturing the polymer film, and a roll.

### CROSS-REFERENCE TO RELATED APPLICATIONS

This application is a continuation application of International Application No. PCT/JP2018/008173, filed Mar. 2, 2018, the disclosure of which is incorporated herein by reference in its entirety. Further, this application claims priority from Japanese Patent Application No. 2017-066078, filed Mar. 29, 2017, the disclosure of which is incorporated herein by reference in its entirety.

### BACKGROUND OF THE INVENTION

### 1. Field of the Invention

The present disclosure relates to a laminated film and a method of manufacturing the laminated film, a polymer film and a method of manufacturing the polymer film, and a roll.

### 2. Description of the Related Art

In recent years, for example, polymer films (for example, single-layer films containing a polymer) with a thickness of 5 nm to 1,000 nm have been developed for the purpose of application to a living body.

WO2008/050913A describes a thin film-like polymer structure having a functional substance in a front surface (A-side) and a rear surface (B-side) of a film.

JP2016-022622A describes a sheet-like laminate formed by laminating a polymer thin film on a release sheet, in which a film thickness of the polymer thin film is set to a value within a range of 5 nm to 1,000 nm, surface free energy of the release sheet at the contacting surface with the polymer thin film is set to a value of 40 mJ/m² or less, and arithmetic average roughness Ra is set to a value of 10 nm or less.

### SUMMARY OF THE INVENTION

The above-described polymer films with a thickness of 5 nm to 1,000 nm are proposed to be used as external skin preparations such as skincare articles (see, for example, WO2008/050913A) or wound dressing materials for body surfaces and organs (see, for example, WO2008/050913A and JP2016-022622A) in view of the fact that the polymer film is flexible, easily follows the fine roughness of a living body, and has high adhesiveness to a living body.

It is thought that the polymer film is preferably a material excellent in bioapplicability. The bioapplicability refers to, for examples, high following properties to the fine roughness on a living body, high adhesiveness to a living body, or less adverse effects of a residual organic solvent in the polymer film on a living body.

In addition, manufacturing the polymer film through a method excellent in productivity is thought to be industrially very useful.

However, a film whose thickness is within the above range is difficult to handle, and is difficult to peel off after being formed on a base.

For example, WO2008/050913A proposes a technology including: providing a target polymer film; laminating a support soluble in a specific solvent on the polymer film to provide a handleable thickness; peeling the laminate from the base; and dipping the laminate to dissolve the support layer, thereby obtaining a single-layer polymer film (single-layer film). For example, a polylactic acid film with a thickness of several tens of nm is formed by spin coating on a SiO₂ base, and a support layer formed of a water-soluble polyvinyl alcohol is provided thereon by spin coating to provide a laminated film with a handleable thickness. The laminated film is peeled from the substrate, and then dipped in pure water to dissolve the polyvinyl alcohol support layer, whereby a single-layer film of polylactic acid with the above thickness is obtained.

The inventors have found that the above manufacturing method has problems in that a plurality of steps are required such as a step of forming a target film, a step of laminating a support, and a step of dissolving the support film after peeling, and the manufacturing efficiency is very low since the single-layer film is manufactured one by one.

JP2016-022622A describes a technology for obtaining a laminated film formed of a polylactic acid layer with a thickness of 200 nm and a polyvinyl alcohol layer by continuously applying a polylactic acid film and a water-soluble polyvinyl alcohol film to a release film having good peelability in sequence through a roll-to-roll method using a gravure coater in order to improve the manufacturing efficiency.

The inventors have found that although the above manufacturing method has achieved a significant improvement in manufacturing efficiency with respect to the technology of WO2008/050913A, a plurality of steps are required such as a step of forming a release film, a step of dissolving a polylactic acid in an organic solvent, and applying and drying the mixture, and a step of dissolving a polyvinyl alcohol in a solvent, and applying and drying the mixture, and the manufacturing efficiency is not sufficient.

The inventors have also found that the above method has a problem in that since it is necessary to dissolve a polylactic acid in an organic solvent in order to apply the polylactic acid, the organic solvent may remain at a low concentration in the obtained polylactic acid film with a nano thickness, and may have adverse effects in application to a living body.

An object of embodiments of the present disclosure is to provide a laminated film which allows obtaining a polymer film excellent in bioapplicability and is excellent in productivity, a roll including the laminated film, and a method of manufacturing the laminated film.

Another object of embodiments of the present disclosure is to provide a polymer film which is obtained using the laminated film and is excellent in bioapplicability, and a method of manufacturing the polymer film.

Specific means for achieving the object includes the following aspects.

<1> A laminated film comprising, in order: a layer containing a thermoplastic polymer A with a thickness of 5 nm to 1,000 nm; a layer containing a water-soluble thermoplastic polymer B; and a layer containing a thermoplastic polymer C, the layers being adjacent to each other, in which the layer containing the thermoplastic polymer A contains no organic solvent, or an organic solvent content in the layer containing the thermoplastic polymer A is greater than 0 mass % and less than 0.01 mass % with respect to a total mass of the layer containing the thermoplastic polymer A.

<2> The laminated film according to <1>, in which a difference between glass transition temperatures of the thermoplastic polymer A and the thermoplastic polymer B is 20° C. or less.

<3> The laminated film according to <1> or <2>, in which thickness uniformity of the layer containing the thermoplastic polymer A in a width direction and in a longitudinal direction of the laminated film is within a range of ±15%.

<4> The laminated film according to any one of <1> to <3>, in which the thermoplastic polymer A includes at least one type of resin selected from the group consisting of a polylactic acid, a poly(lactide-co-glycolide) copolymer, polycaprolactone, polyethylene, polypropylene, polyethylene terephthalate, polyvinyl chloride, and polycarbonate.

<5> A polymer film which is obtained by water-treating the laminated film according to any one of <1> to <4>, the film comprising: the layer containing the thermoplastic polymer A.

<6> A roll comprising: the laminated film according to any one of <1> to <4>, which is wound into a roll of 200 mm or greater in width×10 m or greater in length.

<7> A method of manufacturing a laminated film, the method comprising: a step of melt co-extruding a layer containing a thermoplastic polymer A with a thickness of 5 nm to 1,000 nm, a layer containing a water-soluble thermoplastic polymer B, and a layer containing a thermoplastic polymer C so as to laminate the layers in order, in which the layer containing the thermoplastic polymer A contains no organic solvent, or an organic solvent content in the layer containing the thermoplastic polymer A is greater than 0 mass % and less than 0.01 mass % with respect to a total mass of the layer containing the thermoplastic polymer A.

<8> A method of manufacturing a polymer film, the method comprising: a step of water-treating the laminated film according to any one of <1> to <4>.

According to an embodiment of the present disclosure, it is possible to provide a laminated film which allows obtaining a polymer film excellent in bioapplicability and is excellent in productivity, a roll including the laminated film, and a method of manufacturing the laminated film.

According to another embodiment of the present disclosure, it is possible to provide a polymer film which is obtained using the laminated film and is excellent in bioapplicability, and a method of manufacturing the polymer film.

### DESCRIPTION OF THE PREFERRED EMBODIMENTS

In the present disclosure, a numerical value range expressed using “to” means a range including numerical values before and after “to” as a lower limit value and an upper limit value.

In the present disclosure, the amount of each component in a composition means, in a case where there is a plurality of substances corresponding to each component in the composition, a total amount of the above plurality of substances present in the composition unless otherwise specified.

In the present disclosure, the term “step” includes not only an independent step, but also a step which can achieve the desired object of the step even in a case where the step cannot be clearly distinguished from the other steps.

In the present disclosure, the term “(meth)acrylic” means at least one of acrylic or metacrylic, and the term “(meth)acrylate” means at least one of acrylate or methacrylate.

In the present disclosure, the term “solid content” refers to all components except solvent.

In the present disclosure, a combination of preferable embodiments is a more preferable embodiment.

(Laminated Film)

A laminated film according to the embodiment of the present disclosure includes, in order, a layer containing a thermoplastic polymer A with a thickness of 5 nm to 1,000 nm, a layer containing a water-soluble thermoplastic polymer B, and a layer containing a thermoplastic polymer C, which are adjacent to each other. The organic solvent content of the layer containing the thermoplastic polymer A is less than 0.01 mass % with respect to a total mass of the layer containing the thermoplastic polymer A.

In a general method of manufacturing a polymer film with a thickness of 5 nm to 1,000 nm, a target film is formed on a base having a smooth surface, such as a silicon wafer or a base film, and then the film is peeled from the base.

The inventors have conducted intensive studies, and as a result, found that according to the embodiment of the laminated film of the present disclosure, a polymer film excellent in bioapplicability can be obtained, and the productivity is excellent.

The detailed mechanism in which the above effects are obtained is presumed as follows, but is not limited thereto.

In obtaining a polymer film using the laminated film according to this embodiment, for example, the layer containing the thermoplastic polymer A with a thickness of 5 nm to 1,000 nm (hereinafter, also referred to as “layer A”) and the layer containing the water-soluble thermoplastic polymer B (hereinafter, also referred to as “layer B”) are peeled from the layer containing the thermoplastic polymer C (hereinafter, also referred to as “layer C”). The laminate having the layer A and the layer B thus obtained is treated (water-treated) using water or a composition containing water (for example, saline) to dissolve the layer B, and the layer A remaining as a polymer film can be obtained.

Here, since the layer A has a thickness of 5 nm to 1,000 nm, it is thought to be excellent in following properties when being adhered to a living body, and to have high adhesiveness to the living body.

In the present disclosure, the living body refers to a part of a human being or a living thing other than the human being, and includes, for example, skin, organs, blood vessels, bones, and other body tissues.

In addition, since the layer A contains no organic solvent, or the organic solvent content in the layer A is greater than 0 mass % and less than 0.01 mass % with respect to the total mass of the layer A, the residual organic solvent in the polymer film obtained by separating the layer A from the laminated film is thought to have less adverse effects on a living body.

Accordingly, the polymer film which is obtained by the laminated film according to the embodiment of the present disclosure is thought to be excellent in bioapplicability.

The laminated film according to the embodiment of the present disclosure can be manufactured by melt co-extrusion, and is thought to have high productivity.

Here, the limit of the thickness in a usual melt co-extrusion method is at least about 1.6 μm.

The laminated film according to the embodiment of the present disclosure is thought to be very useful in view of the fact that it has the layer B and the layer C, which are finally removable layers, so that the layer A having a thickness of 5 nm to 1,000 nm can be manufactured by a melt co-extrusion method.

Hereinafter, the components contained in the laminated film according to the embodiment of the present disclosure will be described in detail.

<Layer A>

The layer A is a layer containing a thermoplastic polymer A with a thickness of 5 nm to 1,000 nm, in which no organic solvent is contained, or the organic solvent content in the layer A is greater than 0 mass % and less than 0.01 mass % with respect to the total mass of the layer A.

[Thickness of Layer A]

The thickness of the layer A is 5 nm to 1,000 nm, and preferably 20 nm to 500 nm from the viewpoint of following properties and adhesiveness to a living body.

In a case where the thickness is 1,000 nm or less, the following properties, flexibility, and adhesiveness for a case where a polymer film having the layer A is adhered to a living body are improved, and in a case where the thickness is 5 nm or greater, the polymer film having the layer A obtains a strength and handling suitability.

From the viewpoint of following properties to a living body, the thickness is preferably 5 nm to 700 nm, more preferably 5 nm to 500 nm, even more preferably 5 nm to 300 nm, and particularly preferably 5 nm to 200 nm.

The layer A may be a single layer or a multi-layer in which two or more layers are laminated, as long as the above-described thickness is satisfied.

The layer A can be separated from the laminated film by removing the layer B and the layer C to be described later, and the separated layer A can be used as a polymer film having a thickness of 5 nm to 1,000 nm.

Thickness Measurement Method

The thickness of the layer A is measured by the following method.

In a case where one end of the laminated film in a longitudinal direction is defined as 0%, and the other end is defined as 100%, sampling is performed on the laminated film at positions of 0%, 25%, 50%, 75%, and 100% to take samples of 30 mm in the longitudinal direction across the full width in a width direction.

From the five film pieces sampled, polymer films having the layer A obtained by a method to be described later are attached on a smooth glass substrate with a level difference.

In the five polymer films obtained, in a case where one end in the width direction is defined as 0%, and the other end is defined as 100%, a level difference portion of the single-layer film and the glass substrate is measured by an observation interference-type surface analyzer (Zygo) (NewView 7200 manufactured by Canon Inc.) at five positions of 10%, 30%, 50%, 70%, and 90%, that is, at 25 positions in total, and a layer thickness is calculated from the height difference between the levels at each position. Then, an arithmetic average value of the layer thicknesses at 25 positions in total is calculated and defined as a thickness of the layer A.

In the laminated film according to the embodiment of the present disclosure, the longitudinal direction refers to a transport direction (MD, Machine Direction), and the width direction refers to a direction (TD, Transverse Direction) perpendicular to the transport direction on the film surface.

The polymer film having the layer A is obtained by the following method.

A laminate including the layer B and the layer A is peeled from the layer C by hand or the like, and then dipped in pure water to dissolve and remove the layer B. Then, the film having the layer A remaining in the pure water is lifted out and dried on a smooth glass substrate to attach the polymer film having the layer A on the smooth glass substrate.

[Thickness Uniformity of Layer A]

The thickness uniformity of the layer containing the thermoplastic polymer A in the width direction and in the longitudinal direction of the laminated film according to the embodiment of the present disclosure is preferably within a range of ±15%, and more preferably ±12%.

In a case where the thickness uniformity is within a range of ±15%, sufficient adhesiveness is obtained when the polymer film having the layer A is applied to a living body. In addition, the tension that is applied to the film during handling becomes nearly uniform, and thus stable handling becomes possible. Furthermore, peelability of the layer A from the layer B is improved, and the polymer film having the layer A can be easily obtained.

Thickness Uniformity Measurement Method

With respect to five thicknesses at the position of 0% in the longitudinal direction obtained by the above-described thickness measurement method, a value obtained by subtracting the minimum value from the maximum value is divided by an arithmetic average thickness of the five thicknesses, and then multiplied by 100. The resulting value is defined as thickness uniformity at the position of 0% in the longitudinal direction. Also, thickness uniformity is similarly defined at the positions of 25%, 50%, 75%, and 100% in the longitudinal direction, and among the thickness uniformity at the positions of 0%, 25%, 50%, 75%, and 100% in the longitudinal direction, the largest value is defined as the thickness uniformity in the longitudinal direction.

In addition, with respect to five thicknesses at the position of 10% in the width direction obtained by the above-described thickness measurement method, a value obtained by subtracting the minimum value from the maximum value is divided by an arithmetic average thickness of the five thicknesses, and then multiplied by 100. The resulting value is defined as thickness uniformity at the position of 10% in the width direction. Also, thickness uniformity is similarly defined at the positions of 30%, 50%, 70%, and 90% in the width direction, and among the thickness uniformity at the positions of 10%, 30%, 50%, 70%, and 90% in the width direction, the largest value is defined as the thickness uniformity in the width direction.

[Organic Solvent Content]

The layer containing the thermoplastic polymer A contains no organic solvent, or the organic solvent content in the layer containing the thermoplastic polymer A is greater than 0 mass % and less than 0.01 mass % with respect to the total mass of the layer containing the thermoplastic polymer A. Containing no organic solvent is more preferable.

In a case where the organic solvent content is 0.01% by mass or greater, there may be adverse effects such as allergy in applying the film having the layer A as a polymer film to a living body.

To measure the organic solvent content, a polymer film having the layer A, obtained by a method similar to the method in the above-described thickness measurement method, is extracted alone by 100 mm×100 mm using a sharp edged tool, and measurement was performed using a gas chromatograph (GC-18A, manufactured by Shimadzu Corporation).

[Thermoplastic Polymer A]

The thermoplastic polymer A is not particularly limited, and may be selected from known thermoplastic polymers according to the purpose.

The thermoplastic polymer A is preferably a water-insoluble polymer from the viewpoint of removal of the layer B by a treatment using water.

In the present disclosure, the term water-insoluble means that the solubility of a target substance in water at 25° C. is less than 0.1 mass %. The term water-soluble means that a target substance dissolves in water in an amount of 0.1 mass % or greater at 25° C.

As the thermoplastic polymer A, for example, a bioabsorbable resin is preferable from the viewpoint of being used as a wound dressing material for organs.

The thermoplastic polymer A preferably includes at least one type of resin selected from the group consisting of polyester such as a polylactic acid (PLA, may be a poly-L-lactic acid (PLLA)), a poly(lactide-co-glycolide) copolymer (PLGA), polycaprolactone (PCL), polyethylene (PE), polypropylene (PP), and polyethylene terephthalate (PET), polyvinyl chloride (PVC), and polycarbonate (PC).

From the viewpoint of bioabsorbability, PLLA, PLGA, and PCL are preferable.

These resins may be modified by a known method.

The thermoplastic polymer A may include these resins singly, or may be a mixture of two or more polymers.

Glass Transition Temperature

The glass transition temperature (Tg) of the thermoplastic polymer A is preferably 30° C. to 110° C., and more preferably 40° C. to 100° C.

A difference between the glass transition temperature of the thermoplastic polymer A and the glass transition temperature of the thermoplastic polymer B is preferably 20° C. or lower, and more preferably 15° C. or lower. In a case where the difference is 20° C. or lower, lamination in a nearly uniform state is easily performed in melt laminated film formation by co-extrusion, and a laminated film excellent in thickness uniformity is easily obtained. As a result, sufficient adhesiveness is obtained when the layer A is separated from the laminated film and adhered to a living body as a polymer film. In addition, the polymer film can be stably handled.

<<Glass Transition Temperature Measurement Method>>

In this embodiment, the glass transition temperature of a resin such as a polymer is measured using differential scanning calorimetry (DSC).

Specifically, the measurement is performed according to the method described in JIS K 7121 (1987) or JIS K 6240 (2011). In this specification, an extrapolation glass transition start temperature (hereinafter, may be referred to as Tig) is used as the glass transition temperature.

The glass transition temperature measurement method will be described in more detail.

In obtaining a glass transition temperature, a polymer is held at a temperature about 50° C. lower than Tg of the polymer to be anticipated until the device is stabilized, and then at a heating rate of 20° C./min, the polymer is heated to a temperature about 30° C. higher than a temperature at which the glass transition is completed to draw a differential thermal analysis (DTA) curve or a DSC curve.

An extrapolation glass transition start temperature (Tig), that is, a glass transition temperature Tg in this specification is obtained as a temperature at an intersection point of a straight line, in which the baseline on the low temperature side is extended to the high temperature side in the DTA curve or the DSC curve, with a tangent drawn at a point where the gradient of the curve in a stepwise glass transition change portion is maximum.

In a case where the thermoplastic polymer A is a mixture of two or more types of polymers, the measurement method is considered as follows. For example, in a case where three types of polymers (polymer 1 to polymer 3) are contained, the glass transition temperature of the polymer 1 is denoted by Tg1 (K), the mass fraction is denoted by Ml, the glass transition temperature of the polymer 2 is denoted by Tg2 (K), the mass fraction is denoted by M2, the glass transition temperature of the polymer 3 is denoted by Tg3 (K), and the mass fraction is denoted by M3, an average value Tgm (K) of the glass transition temperatures of the mixed components can be estimated by the following formula.

1/Tgm=(M1/Tg1)+(M2/Tg2)+(M3/Tg3)

Weight-Average Molecular Weight

The weight-average molecular weight of the thermoplastic polymer A is preferably 120,000 to 240,000, and more preferably 150,000 to 200,000.

In the present disclosure, the term “polymer” refers to a compound having a weight-average molecular weight of 5,000 or greater.

In the present disclosure, unless otherwise specified, the weight-average molecular weight (Mw) and the number-average molecular weight (Mn) are molecular weights obtained through the detection by a gel permeation chromatography (GPC) analyzer using TSKgel GMHxL, TSKgel G4000HxL, and TSKgel G2000HxL (trade names, all manufactured by TOSOH CORPORATION) as columns with tetrahydrofuran (THF) as a solvent and a differential refractometer, and conversion using a polystyrene as a standard substance.

[Other Components]

The layer A may contain known additives as other components, but preferably contains no other components from the viewpoint of applicability to a living body for a case where the layer A is separated from the laminated film and used as a polymer film.

The content of the thermoplastic polymer A in the layer A is preferably 90 mass % to 100 mass %, more preferably 95 mass % to 100% by mass, and even more preferably 100 mass % with respect to the total mass of the layer A.

<Layer B>

The layer B is a layer containing a water-soluble thermoplastic polymer B.

[Thermoplastic Polymer B]

The thermoplastic polymer B is not particularly limited as long as it is a water-soluble polymer, and a known polymer can be used.

The thermoplastic polymer B can be dissolved in, for example, water, warm water, physiological saline, and the like.

Specific examples of the thermoplastic polymer B preferably include polyvinyl alcohols or copolymers thereof, water-soluble polyesters or copolymers thereof, chitosan, alginic acid or salts thereof, starches, hyaluronic acid, cellulose, acrylic polymers, urethane polymers, and ether polymers. Among these, polyvinyl alcohols are preferable from the viewpoint of manufacturing cost, availability, and hygiene.

[Other Components]

The layer B may contain known additives as other components. Examples of the known additives include a heat stabilizer, an antioxidant, an antistatic agent, an ultraviolet absorber, particles, a lubricant, an antiblocking agent, a light resistant agent, an impact modifier, a dye, and a pigment.

The content of the thermoplastic polymer B in the layer B is preferably 90 mass % or greater, more preferably 95 mass % or greater, and even more preferably 98 mass % or greater with respect to the total mass of the layer B. The upper limit thereof is not particularly limited, and may be 100 mass % or less.

[Thickness of Layer B]

The thickness of the layer B is not particularly limited, and preferably 50 nm to 1,000 nm, and more preferably 100 nm to 3,000 nm from the viewpoint of following properties.

The thickness of the layer B is measured by the following method.

In a case where one end of the laminated film in the longitudinal direction is defined as 0%, and the other end is defined as 100%, sampling is performed on the laminated film at positions of 0%, 25%, 50%, 75%, and 100% to take samples of 30 mm in the longitudinal direction across the full width in the width direction.

From the five film pieces sampled, the layer C is peeled by hand to obtain polymer films having the layer A and the layer B, and the polymer films are attached on a smooth glass substrate with a level difference.

In the five polymer films obtained, in a case where one end in the width direction is defined as 0%, and the other end is defined as 100%, a level difference portion of the single-layer film and the glass substrate is measured by an observation interference-type surface analyzer (Zygo) (NewView 7200 manufactured by Canon Inc.) at five positions of 10%, 30%, 50%, 70%, and 90%, that is, at 25 positions in total, and a layer thickness is calculated from the height difference between the levels at each position. Then, from an arithmetic average value of the layer thicknesses at 25 positions in total, the thickness of the layer A described above is subtracted, and the resulting value is defined as a thickness of the layer B.

<Layer C>

The layer C is a layer containing a thermoplastic polymer C.

[Thermoplastic Polymer C]

The thermoplastic polymer C is not particularly limited, and a known thermoplastic polymer may be used. It preferably includes any of PLA (PLLA), PLGA, PCL, PE, PP, PET, PVC, and PC.

The thermoplastic polymer C may include these resins singly, or may be a mixture of these resins.

Among these, PE is preferable from the viewpoint of availability and cost.

[Other Components]

The layer C may contain known additives as other components. Examples of the known additives include a heat stabilizer, an antioxidant, an antistatic agent, an ultraviolet absorber, particles, a lubricant, an antiblocking agent, a light resistant agent, an impact modifier, a dye, and a pigment.

The content of the thermoplastic polymer C in the layer C is preferably 90 mass % or greater, more preferably 95 mass % or greater, and even more preferably 98 mass % or greater with respect to the total mass of the layer C. The upper limit thereof is not particularly limited, and may be 100 mass % or less.

[Thickness of Layer C]

The thickness of the layer C is not particularly limited, and preferably 20 μm to 100 μm, and more preferably 30 μm to 80 μm from the viewpoint of following properties.

The thickness of the layer C is measured by the following method.

In a case where one end of the laminated film in the longitudinal direction is defined as 0%, and the other end is defined as 100%, sampling is performed on the laminated film at positions of 0%, 25%, 50%, 75%, and 100% to take samples of 30 mm in the longitudinal direction across the full width in the width direction.

From the five film pieces sampled, the layer C is peeled by hand to obtain polymer films having the layer A and the layer B, and the polymer films are attached on a smooth glass substrate with a level difference.

In the five polymer films obtained, in a case where one end in the width direction is defined as 0%, and the other end is defined as 100%, a level difference portion of the single-layer film and the glass substrate is measured by a contact-type thickness gauge (PG-02J manufactured by Teclock Co., Ltd.) at five positions of 10%, 30%, 50%, 70%, and 90%, that is, at 25 positions in total, and an arithmetic average value of the layer thicknesses at 25 positions in total is calculated and defined as a thickness of the layer C.

<Other Layers>

The laminated film according to the embodiment of the present disclosure may have other layers.

As other layers, for example, a layer containing a water-soluble resin may be further provided on the side of the layer A opposite to the layer B in order to protect the layer A. Examples of the layer containing the water-soluble resin include layers similar to the layer B according to the present disclosure.

Examples of the layer configuration include layer C-layer B-layer A, layer C-layer B-layer A-layer B, layer C-layer B-layer A-layer C, and layer C-layer B-layer A-layer B-Layer C.

(Method of Manufacturing Laminated Film)

The laminated film according to the embodiment of the present disclosure is preferably formed by a melt laminated film forming method called a co-extrusion method. By the co-extrusion method, a laminated film which is excellent in productivity and has a low organic solvent concentration is easily obtained in comparison with the prior art. In addition, the co-extrusion method is very useful in view of the fact that a laminated film having a relatively large area is easily manufactured in comparison with the prior art.

The manufacturing method based on the co-extrusion method is not particularly limited, and a known method is exemplified.

From the viewpoint of an improvement in productivity, the method of manufacturing a laminated film according to the embodiment of the present disclosure is preferably a method of manufacturing a laminated film including a step (co-extrusion step) of melt co-extruding a layer containing a thermoplastic polymer A with a thickness of 5 nm to 1,000 nm (layer A), a layer containing a water-soluble thermoplastic polymer B (layer B), and a layer containing a thermoplastic polymer C (layer C) so as to laminate the layers in order, in which the layer containing the thermoplastic polymer A contains no organic solvent, or the organic solvent content in the layer containing the thermoplastic polymer A is greater than 0 mass % and less than 0.01 mass % with respect to the total mass of the layer containing the thermoplastic polymer A.

<Co-Extrusion Step>

In the co-extrusion step, a resin component A containing a thermoplastic polymer A, a resin component B containing a thermoplastic polymer B, and a resin component C containing a thermoplastic polymer C are co-extruded to laminate a layer A, a layer B, and a layer C in order.

A preferable aspect of the components contained in the resin component A, the resin component B, and the resin component C is similar to the preferable aspect of the components contained in the layer A, the layer B, and the layer C described above.

The resin component A, the resin component B and the resin component C are each preferably injected into an extruder after drying. Particularly, by drying the resin component A, the organic solvent content in the layer A to be obtained is easily adjusted. The drying temperature may be appropriately set according to the type of the resin, and is preferably 50° C. to 200° C., and more preferably 60° C. to 100° C. The drying time is preferably 0.5 hours to 24 hours, and more preferably 5 hours to 12 hours.

The water content of the raw material resins of the resin component A, the resin component B, and the resin component C after drying is preferably 10 ppm to 300 ppm, and more preferably 20 ppm to 150 ppm.

Preferably, the resin component A, the resin component B, and the resin component C are respectively melted and kneaded, and then the melted materials (melts) are co-extruded on a cast drum through a multi-layer die. The melts are solidified on the cast, formed into a film, and obtained as a cast film (un-stretched film).

As a multi-layer die system, either a multi-manifold die or a feed block die can be suitably used. The die may have a T-die shape, a hanger coat die shape, a fish tail shape, or the like. The melted resin (melt) preferably passes through a gear pump and a filter through a melt pipe.

The pore size of the filter is preferably 1 μm to 50 μm, more preferably 5 μm to 40 μm and even more preferably 10 μm to 30 μm. In addition, a static mixer is preferably provided in the melt pipe to promote mixing of the resin and the additive.

The temperature of the cast drum is preferably 0° C. to 60° C., more preferably 5° C. to 55° C., and even more preferably 10° C. to 50° C. In this case, a static electricity application method, an air knife method, water coating on a cast drum, or the like is also preferably used in order to improve adhesiveness between the melted resin and the cast drum, thereby improving planarity. For further efficient cooling, cold air may be blown from above the cast drum.

The extrusion is preferably performed under vacuum exhaust or under an inert gas atmosphere. The temperature of the extruder is within a temperature range preferably ranging from the melting point of the resin to be used to the melting point+80° C., more preferably from the melting point+5° C. to the melting point+70° C., and even more preferably from the melting point+10° C. to the melting point+50° C.

In a case where the temperature of the extruder is equal to or higher than the melting point of the resin, the resin is melted well. In a case where the temperature of the extruder is equal to or lower than the “melting point+80° C”, modification of the resin is suppressed.

<Stretching Step>

The method of manufacturing a laminated film according to the embodiment of the present disclosure may include a step (stretching step) of biaxially stretching the un-stretched film obtained by the co-extrusion step in a longitudinal direction (hereinafter, also referred to as a longitudinal direction, MD) and a width direction (hereinafter, also referred to as a transverse direction, TD).

The thickness of the layer A is easily adjusted to 5 nm to 1,000 nm in a case where the stretching step is included.

The stretching method includes a sequential biaxial stretching method in which stretching is performed in a longitudinal direction, and then performed in a width direction, a simultaneous biaxial stretching method in which stretching is simultaneously performed in a longitudinal direction and in a width direction using a simultaneous biaxial tenter or the like, and a method in which the sequential biaxial stretching method and the simultaneous biaxial stretching method are combined.

From the viewpoint of controlling the surface area of the voids of the first layer, the method of manufacturing a laminated film according to the embodiment of the invention is preferably a sequential biaxial stretching method in which stretching is performed in a longitudinal direction, and then performed in a width direction.

Examples of the sequential biaxial stretching method include a biaxial stretching method in which using a longitudinal stretching machine in which several rolls are disposed, an un-stretched film is stretched (MD stretching, longitudinal stretching) in a longitudinal direction by the use of a circumferential speed difference of the rolls, and then stretched (TD stretching, transverse stretching) in a transverse direction by a tenter.

In the biaxial stretching method, first, the un-stretched film is preferably subjected to MD stretching. In addition, the un-stretched film is preferably sufficiently pre-heated prior to the MD stretching. The pre-heating temperature is preferably 40° C. or higher and 90° C. or lower, more preferably 50° C. or higher and 85° C. or lower, and even more preferably 60° C. or higher and 80° C. or lower. Such pre-heating is performed by passing the un-stretched film on a heating (temperature-adjusting) roll, and the pre-heating time is preferably 1 second or longer and 120 seconds or shorter, more preferably 5 seconds or longer and 60 seconds or shorter, and even more preferably 10 seconds or longer and 40 seconds or shorter.

The MD stretching may be performed in one stage or in multiple stages. In a case where the MD stretching is performed in one stage, the temperature is preferably the glass transition temperature Tg or higher and Tg+15° C. or lower (more preferably Tg+10° C. or lower), and the stretching ratio is preferably 2.0 times to 5.0 times, more preferably 3.0 times to 4.5 times, and even more preferably 3.5 times to 4.0 times. After stretching, cooling is preferably performed by a cooling roll group at a temperature of 20° C. to 50° C. In a case where the stretching ratio is equal to or higher than the lower limit value of the above ratio, an amorphous portion to be generated with this can exhibit sufficient orientation, and peeling troubles are hardly generated. It is preferable that the stretching ratio is equal to or lower than the upper limit value of the above range since longitudinal orientation is not extremely strong, cleavage (interlayer peeling of the laminated film) hardly occurs, and peeling troubles are hardly generated.

In a case where the longitudinal stretching is performed in multiple stages, in initial low-temperature stretching (MD stretching 1), heating is performed by a heating roll group within a range of (Tg-20)° C. to (Tg+10)° C., and more preferably (Tg-10)° C. to (Tg+5)° C., and stretching is performed at a stretching ratio of 1.1 times to 2.0 times, and more preferably 1.2 times to 1.5 times. Next, MD stretching 2 is performed at a higher temperature of (Tg+10)° C. to (Tg+50)° C. than the temperature of the MD stretching 1. More preferably, the temperature is (Tg+15)° C. to (Tg+30)° C. The stretching ratio of the MD stretching 2 is preferably 1.2 times to 3.0 times, and more preferably 1.5 times to 3.0 times. The combined MD stretching ratio of the MD stretching 1 and the MD stretching 2 is preferably 2.0 times to 5.0 times, more preferably 3.0 times to 4.5 times, and even more preferably 3.5 times to 4.0 times. The ratio of the stretching ratio in the second stage to the stretching ratio in the first stage (second stage/first stage, referred to as a multi-stage stretching ratio) is preferably 1.1 or greater and 3 or less, more preferably 1.15 or greater and 2 or less, and even more preferably 1.2 or greater and 1.8 or less. It is preferable that the multi-stage stretching ratio is equal to or lower than the lower limit value of the above range since peeling troubles are hardly generated as in the case of the one-stage stretching.

Next, stretching in a width direction is preferably performed using a tenter (may be referred to as a stenter). The stretching ratio is preferably 1.5 times to 5.0 times, more preferably 2.0 times to 4.5 times, and even more preferably 2.5 times to 4.0 times. The temperature is preferably within a range of (Tg)° C. to (Tg+50) ° C., and more preferably (Tg)° C. to (Tg+30)° C.

The surface area of the voids of the first layer in the laminated film can be adjusted by the stretching temperature or the stretching rate in the stretching step.

<Thermal Fixation Step>

A thermal fixation step may be included in which thermal fixation (heat treatment) is performed on the film after stretching in two directions. The thermal fixation can be performed by a known optional method in a tenter or a heating oven, or on a heated roll.

In the thermal fixation step, the heat treatment is performed on the film preferably at 60° C. to 130° C., and more preferably 70° C. to 120° C. for 1 second to 60 seconds (more preferably 5 seconds to 50 seconds).

By performing the thermal fixation step, it is possible to appropriately release the tension of the molecules caused by the stretching and to reduce the thermal contraction (the thermal contraction appears in a case where the tension of the molecules caused by the orientation is released).

The thermal fixation is generally performed at a temperature equal to or lower than the melting point of the resin. However, in the invention, the thermal fixation is preferably performed at the above-described temperatures. In this case, relaxation is also preferably performed as described above in at least one of the longitudinal direction or the transverse direction.

<Winding Step>

The method of manufacturing a laminated film preferably further includes a step (winding step) of winding the film obtained as described above.

The winding step is not particularly limited, and a known method may be used. Examples thereof include a method in which a film coming out of a tenter is trimmed at both ends held by a clip, and then wound.

The width of the film to be wound is preferably 80 mm to 10,000 mm, more preferably 100 mm to 6,000 mm, and even more preferably 200 mm to 4,000 mm.

The length of the film to be wound is not particularly limited, and preferably 2 m or longer, more preferably 5 m or longer, and even more preferably 10 m or longer.

<<Other Steps>>

The method of manufacturing a laminated film according to the embodiment of the present disclosure may further include other steps.

Examples of other steps include a thermal relaxation step. The thermal relaxation step is a treatment in which heat is applied to the film to relax stress, thereby contracting the film. In the thermal relaxation step, relaxation is preferably performed in at least one of the longitudinal direction or the transverse direction, and the amount of relaxation is preferably 1% to 15% (ratio with respect to the width after transverse stretching) in both the longitudinal and transverse directions, more preferably 2% to 10%, and even more preferably 3% to 8%. The relaxation temperature is preferably Tg+50° C. to Tg+180° C., more preferably Tg+60° C. to Tg+150° C., and even more preferably Tg+70° C. to Tg+140° C.

(Polymer Film)

A polymer film according to the embodiment of the present disclosure is obtained by water-treating the laminated film according to the embodiment of the present disclosure, and has the layer containing the thermoplastic polymer A.

The water treatment method is not particularly limited, and examples thereof include a method in which the layer C is peeled from the laminated film according to the embodiment of the present disclosure by hand or the like, and then the layer B is dissolved and removed with water or a composition containing water.

Preferable components contained in the polymer film and preferable properties such as the thickness of the polymer film are as described in the description of the layer A.

(Method of Manufacturing Polymer Film)

The method of manufacturing a polymer film according to the embodiment of the present disclosure preferably includes a step of water-treating the laminated film according to the embodiment of the present disclosure.

The water treatment method is not particularly limited, and examples thereof include a method in which the layer C is peeled from the laminated film according to the embodiment of the present disclosure by hand or the like, and then the layer B is dissolved and removed with water or a composition containing water.

(Roll)

The laminated film according to the embodiment of the present disclosure is preferably provided as a wound roll of 200 mm or greater in width×10 m or greater in length.

The term “width” represents a length in the width direction, and the term “length” represents a length in the longitudinal direction.

A roll according to the embodiment of the present disclosure is obtained by winding the laminated film according to the embodiment of the present disclosure into a roll of 200 mm or greater in width×10 m or greater in length.

The winding method is not particularly limited, and a known method can be used. Examples thereof include the method described as the winding step in the method of manufacturing a laminated film according to the embodiment of the present disclosure.

By handling the laminated film according to the embodiment of the present disclosure as a roll, productivity is further improved.

### EXAMPLES

Hereinafter, the invention will be described in more detail by using examples. However, the invention is not limited to the following examples as long as there is no departure from the gist of the invention.

Hereinafter, “parts” is based on mass unless otherwise specified.

<Melt Laminated Film Formation>

### Example 1

As a thermoplastic polymer A, a polylactic acid (TERRAMAC TP-4000 manufactured by UNITIKA LTD.) was dried to have a moisture content of 500 ppm or less, supplied to an extruder 1, and melt-extruded at 190° C. As the extruder 1, a single-axis extruder was used.

As a thermoplastic polymer B, PVA (CP-1220T10 manufactured by Kuraray Co., Ltd.) was dried to have a moisture content of 500 ppm or less, supplied to an extruder 2, and melt-extruded at 190° C. As the extruder 2, a single-axis extruder was used as in the case of the extruder 1.

As a thermoplastic polymer C, a low-density polyethylene (LDPE, NOVATEC LJ802 manufactured by JAPAN POLYETHYLENE CORPORATION) was supplied to an extruder 3, and melt-extruded at 190° C. As the extruder 3, a single-axis extruder was used as in the cases of the extruders 1 and 2.

The melted materials (melts) extruded from outlets of the respective extruders were passed through a gear pump and a metallic fiber filter (with a pore diameter of 20 μm). Then, these were joined together using a three-layer feed block device, and extruded to a cooling roll from a T-die while maintaining a laminated state thereof. A hollow cast roll was used as the cooling roll and could be temperature-controlled by passing a heat medium therethrough.

<Winding>

The melts were extruded on the cooling roll by the above method, and a solidified film of 300 mm in width was produced. Thereafter, the film was trimmed at both ends in a width direction by 50 mm each to obtain a width of 200 mm, and then wound by 50 m around a resin core of 80 mm in diameter.

(Evaluation)

The following measurement and evaluation were performed on the laminated film obtained as described above.

<Extraction of Layer A in Single Layer>

The method of obtaining, from the laminated film, a layer containing a thermoplastic polymer A in a single layer is not particularly limited, and for example, the following method is considered.

The layer B and the layer A were peeled from the layer C by hand or the like, and then dipped in pure water to dissolve and remove the thermoplastic polymer B. Then, the layer A remaining in the pure water was lifted out and dried on a smooth glass substrate to attach the layer A in a single layer on the smooth glass substrate, and a polymer film composed of the layer A was obtained.

<Organic Solvent Content>

The organic solvent content is used as an indicator of the amount of an organic solvent released when the film was applied to a living body. The polymer film composed of the layer A obtained by the above method was extracted alone by 100 mm×100 mm using a sharp edged tool, cut into a size of about 5 mm square, put into a sealed container, and heated. Then, the gas phase in the sealed container was collected, and the film was introduced into a gas chromatograph (GC-18A, manufactured by Shimadzu Corporation) to measure the organic solvent content. The evaluation results are shown in Table 1.

A: The organic solvent content is less than 0.01 mass %. It can be judged that the applicability is high in a case where the layer A was applied to a living body as a polymer film.

B: The organic solvent content is 0.01 mass % or greater. It can be judged that the applicability to a living body is lower than in a case where the evaluation result is A.

<Thickness of Layer A>

In the obtained laminated film roll, in a case where a winding start of the roll was defined as 0%, and a winding end was defined as 100%, sampling was performed on the film at positions of 0%, 25%, 50%, 75%, and 100% to take samples of 30 mm in the longitudinal direction across the full width in the width direction. From the five film pieces sampled, polymer films each composed of the layer A were attached on a smooth glass substrate with a level difference by the above method. In the five single layers obtained, in a case where one end in the width direction was defined as 0%, and the other end was defined as 100%, a level difference portion of the single-layer film and the glass substrate was measured by an observation interference-type surface analyzer (Zygo) (NewView 7200 manufactured by Canon Inc.) at five positions of 10%, 30%, 50%, 70%, and 90%, that is, at 25 positions in total, and a layer thickness was calculated from the height difference between the levels at each position. Then, an arithmetic average value of the layer thicknesses at 25 positions in total was defined as a thickness of the layer to be composed of the polymer A, and evaluated according to the following evaluation criteria. The evaluation results were described in Table 1.

A: The thickness is 5 nm or greater and 1,000 nm or less.

B: The thickness is less than 5 nm, or greater than 1,000 nm.

<Thickness of Layer B>

In the obtained laminated film roll, in a case where a winding start of the roll was defined as 0%, and a winding end was defined as 100%, sampling was performed on the film at positions of 0%, 25%, 50%, 75%, and 100% to take samples of 30 mm in the longitudinal direction across the full width in the width direction. From the five film pieces sampled, the layer C was peeled by hand and removed, and the film composed of the layer A and the layer B which remained was attached on a smooth glass substrate with a level difference. In the obtained five films each composed of the layer A and the layer B, in a case where one end in the width direction was defined as 0%, and the other end was defined as 100%, a level difference portion of the single-layer film and the glass substrate was measured by an observation interference-type surface analyzer (Zygo) (NewView 7200 manufactured by Canon Inc.) at five positions of 10%, 30%, 50%, 70%, and 90%, that is, at 25 positions in total, and a layer thickness was calculated from the height difference between the levels at each position. Then, from an arithmetic average value of the layer thicknesses at 25 positions in total, the thickness of the layer composed of the polymer A evaluated by the above method was subtracted, and the resulting value was defined as a thickness of the layer B and described in Table 1.

<Thickness of Layer C>

In the obtained laminated film roll, in a case where a winding start of the roll was defined as 0%, and a winding end was defined as 100%, sampling was performed on the film at positions of 0%, 25%, 50%, 75%, and 100% to take samples of 30 mm in the longitudinal direction across the full width in the width direction. From the five film pieces sampled, the layer C was peeled by hand. In the obtained five films each composed of the layer C, in a case where one end in the width direction was defined as 0%, and the other end was defined as 100%, measurement was performed by a contact-type thickness gauge (PG-02J manufactured by Teclock Co., Ltd.) at five positions of 10%, 30%, 50%, 70%, and 90%, that is, at 25 positions in total, and an arithmetic average value of the layer thicknesses at 25 positions in total was defined as a thickness of the layer C and described in Table 1.

<Glass Transition Temperature>

From the obtained laminated film, the thermoplastic polymer A and the thermoplastic polymer B were each extracted alone by a sharp edged tool, and the glass transition temperature was measured by DSC (DSC-60A manufactured by Shimadzu Corporation) to perform evaluation according to the following evaluation criteria. The thermoplastic polymer A was extracted after a polymer film composed of the layer A was obtained by the above method. The details of the measurement were as described above. The evaluation results are shown in Table 1.

A: The difference between the glass transition temperatures of the polymer A and the polymer B is 20° C. or less.

B: The difference between the glass transition temperatures of the polymer A and the polymer B exceeds 20° C.

<Thickness Uniformity of Layer A>

The layer thicknesses at 25 positions in total obtained by the above method were analyzed by the following method.

With respect to five thicknesses at the position of 0% in the longitudinal direction, a value obtained by subtracting the minimum value from the maximum value was divided by an arithmetic average thickness of the five thicknesses, and then multiplied by 100. The resulting value was defined as thickness uniformity at the position of 0% in the longitudinal direction. Also, thickness uniformity was similarly defined at the positions of 25%, 50%, 75%, and 100% in the longitudinal direction, and among the thickness uniformity at the positions of 0%, 25%, 50%, 75%, and 100% in the longitudinal direction, the largest value was defined as the thickness uniformity in the longitudinal direction. With respect to five thicknesses at the position of 10% in the width direction, a value obtained by subtracting the minimum value from the maximum value was divided by an arithmetic average thickness of the five thicknesses, and then multiplied by 100. The resulting value was defined as thickness uniformity at the position of 10% in the width direction. Also, thickness uniformity was similarly defined at the positions of 30%, 50%, 70%, and 90% in the width direction, and among the thickness uniformity at the positions of 10%, 30%, 50%, 70%, and 90% in the width direction, the largest value was defined as the thickness uniformity in the width direction. The thickness uniformity in the longitudinal direction (MD uniformity) and the thickness uniformity in the width direction (TD uniformity) were evaluated according to the following evaluation criteria. The evaluation results were described in Table 1.

A: The thickness uniformity is 10% or less.

B: The thickness uniformity is greater than 10% and equal to or less than 15%.

C: The thickness uniformity is greater than 15%.

<Adhesiveness and Following Properties of Layer A to Biological Tissue>

The adhesiveness and the following properties of the layer A to biological tissue were evaluated by the following method. From a central portion in the width direction of the obtained laminated film roll, a square sample of 30 mm in the width direction and 30 mm in the longitudinal direction was taken. Of the sample, the layer composed of the water-soluble thermoplastic polymer B and the layer composed of the thermoplastic polymer A were peeled by hand from the layer composed of the thermoplastic polymer C, and then dipped in an aqueous solution to dissolve and remove the thermoplastic polymer B, and only the layer composed of the thermoplastic polymer A floated in the aqueous solution. The layer A remaining in the aqueous solution was lifted out on water-absorbed, slippery cowhide, brought into close contact therewith, and then left in a moist environment for 72 hours. The layer A after leaving was visually observed to confirm an area where the layer A was brought into close contact with the cowhide and an area where floating, peeling, or tearing occurred, and evaluation was performed according to the following evaluation criteria. The evaluation results were described in the column of “Adhesiveness” in Table 1. It can be said that in the laminated film, the more excellent both the above-described organic solvent content (an indicator of the amount of the organic solvent released) and the adhesiveness in the layer A obtained by separating the layer B and the layer C, the more excellent the bioapplicability in a case where the layer A is used as a polymer film.

A: The close contact area is 90% or greater and 100% or less with respect to the entire film area.

B: The close contact area is 80% or greater and less than 90% with respect to the entire film area.

C: The close contact area is less than 80% with respect to the entire film area.

<Productivity of Laminated Film>

With respect to the laminated film produced by the above method, the production volume per minute (m²/min) was calculated from the time taken for manufacturing the laminated film, and evaluated according to the following evaluation criteria. The evaluation results were described in the column of “Productivity” in Table 1.

A: The production volume is 1 m²/min or greater.

B: The production volume is less than 1 m²/min.

### Examples 2 to 8

Manufacturing and evaluation of a laminated film were performed in the same manner as in Example 1, except that the resins used in the layer A, the layer B, and the layer C, and the thicknesses of the layer A, the layer B, and the layer C were changed as described in Table 1. The thickness of each layer was adjusted by adjusting the co-extrusion amount or the extrusion temperature according to the resin type.

### Example 9

A square sample of 50 mm×50 mm was taken from the laminated film obtained in Example 1 using a sharp edged tool. In the sampled laminated film, the layer B and the layer A were peeled from the layer C by hand, and then dipped in pure water. After the thermoplastic polymer B was dissolved and removed, the layer A remaining in the pure water was lifted out on a smooth glass substrate and dried to attach the layer A in a single layer on the smooth glass substrate, and a polymer film was obtained.

Since the laminated film obtained in Example 1 was used, the results of the measurement of the material of the polymer film obtained, the organic solvent content, the thickness, the glass transition temperature, the MD uniformity, the TD uniformity, and the adhesiveness in Example 9 were similar to those of Example 1.

### Comparative Example 1

A polylactic acid (TERRAMAC TP-4000 manufactured by UNITIKA LTD.) was dissolved in ethyl acetate to prepare a solution for forming a layer A with a concentration of 3 mass %.

A polyvinyl alcohol (CP-1220T10, manufactured by Kuraray Co., Ltd.) was dissolved in pure water to prepare a solution for forming a layer B with a concentration of 20 mass %.

Next, using a reverse gravure coater (μ-coater, manufactured by Yasui Seiki Inc.), the solution for forming a layer B and the solution for forming a layer A obtained were applied and dried in order on an upper surface of a 50 μm-thick polyolefin film (OPYURAN X-88B #50, manufactured by Mitsui Chemicals Tohcello, Inc.) corresponding to a layer C. The solutions were applied such that the thicknesses of the layer B and the layer A after drying were as described in Table 1.

In this case, the gravure roll of the reverse gravure coater used had a line number of 150#, a diameter of 20 mm, and a length in a long-axis direction of 300 mm, the speed of the release sheet was 1 m/min, and the rotational speed of the gravure roll was 160 rpm.

### Comparative Example 2

Octadecyltrimethoxysilane (ODMS) was vapor-deposited on a silicon oxide (SiO₂) substrate, a positive photoresist was applied by a spin coater (800 rpm, 3 seconds+7,000 rpm, 20 seconds), and drying was performed by heating (110° C., 90 seconds). After ultraviolet irradiation was performed on areas other than the area of 10 μm×10 μm through a photomask, a development treatment and a drying operation were performed, and thus a resist pattern was obtained on the substrate. The ODMS unprotected by the resist was removed through an O₂ plasma treatment (30 seconds), and then the resist was removed with acetone to form a hydrophilic/hydrophobic micropattern substrate (ODMS-SiO₂ substrate).

In a case where a PLGA nanoparticle dispersion (1×10¹¹ particles/mL, pH 7.4) was added dropwise to the obtained hydrophilic/hydrophobic micropattern substrate, and blown away with an N₂ gas, the PLGA nanoparticles uniformly adsorbed to the entire substrate. However, in a case where the substrate was washed several times with ultrapure water, the PLGA nanoparticles adsorbed densely only to the region of 10 μm×10 μm where ODMS was vapor-deposited, and selective adsorption was observed.

After the adsorption, the particles were heat-fused by heating at 60° C., and treated with 10 mmol/L MAL-PEG-NHS (α-maleimidyl-ω-N-hydroxysuccinimidyl polyethylene glycol) in DMSO.

After the above treatment, a polyvinyl alcohol aqueous solution of 2.5 mass % was further applied and dried on the layer where the PLGA nanoparticles were adsorbed, and a polyvinyl alcohol layer was formed.

The polyvinyl alcohol layer and the layer where the PLGA nanoparticles were adsorbed were peeled from the substrate, and further treated with 10 mmol/L MAL-PEG-NHS (α-maleimidyl-ω-N-hydroxysuccinimidyl polyethylene glycol) in DMSO.

After the treatment, the polyvinyl alcohol layer was dissolved using a phosphate buffer (pH 7.4) to obtain a polymer film of PLGA.

Using the polymer film of PLGA obtained as described above, the above-described measurement and evaluation were performed. Regarding adhesiveness, since the area of the obtained polymer film was too small, the film was difficult to handle and could not be evaluated. Regarding productivity, the number of steps required to obtain the polymer film was large, and the amount of the polymer film obtained per unit time was small.

TABLE 1

| | Layer A | | | | | | | |
|---|---|---|---|---|---|---|---|---|
| | | Organic Solvent | | Glass Transition | MD | TD | Layer B | |
| | Material | Content | Thickness | Temperature | Uniformity | Uniformity | Material | Thickness |
| Example 1 | PLLA | 0 mass % | 200 nm | 57° C. | 9% | 12% | PVA | 300 nm |
| | | A | A | A | A | B | | |
| Example 2 | PLLA | 0 mass % | 5 nm | 57° C. | 18% | 19% | PVA | 100 nm |
| | | A | A | A | C | C | | |
| Example 3 | PLLA | 0 mass % | 1,000 nm | 57° C. | 7% | 10% | PVA | 1,000 nm |
| | | A | A | A | A | A | | |
| Example 4 | PVC | 0 mass % | 200 nm | 80° C. | 16% | 20% | PVA | 300 nm |
| | | A | A | B | C | C | | |
| Example 5 | PVC | 0 mass % | 200 nm | 80° C. | 8% | 10% | Water-Soluble | 300 nm |
| | | A | A | A | A | A | Polyester | |
| Example 6 | PC | 0 mass % | 1,000 nm | 145° C. | 17% | 19% | PVA | 1,000 nm |
| | | A | A | B | C | C | | |
| Example 7 | PLLA | 0 mass % | 200 nm | 57° C. | 15% | 18% | PVA | 300 nm |
| | | A | A | A | C | C | | |
| Example 8 | PLLA | 0 mass % | 200 nm | 57° C. | 9% | 12% | PVA | 300 nm |
| | | A | A | A | A | B | | |
| Comparative | PLLA | 0.4 mass % | 200 nm | 57° C. | 5% | 7% | PVA | 300 nm |
| Example 1 | | A | A | A | A | A | | |
| Comparative | PLGA | 0 mass % | 20 nm | 57° C. | 33% | 28% | PVA | 50 nm |
| Example 2 | | A | A | A | C | C | | |

| | Layer B | | | | | | | |
|---|---|---|---|---|---|---|---|---|
| | Glass Transition | Layer C | | Roll | | Manufacturing | Evaluation Results | |
| | Temperature | Material | Thickness | Width | Length | Method | Adhesiveness | Productivity |
| Example 1 | 42° C. | PE | 100 μm | 200 mm | 30 m | Melting | 90% | 5 m²/min |
| | | | | | | | A | A |
| Example 2 | 42° C. | PE | 100 μm | 200 mm | 30 m | Melting | 96% | 5 m²/min |
| | | | | | | | A | A |
| Example 3 | 42° C. | PE | 100 μm | 200 mm | 30 m | Melting | 64% | 5 m²/min |
| | | | | | | | C | A |
| Example 4 | 42° C. | PE | 100 μm | 200 mm | 30 m | Melting | 83% | 5 m²/min |
| | | | | | | | B | A |
| Example 5 | 67° C. | PE | 100 μm | 200 mm | 30 m | Melting | 91% | 5 m²/min |
| | | | | | | | A | A |
| Example 6 | 42° C. | PET | 100 μm | 200 mm | 30 m | Melting | 60% | 5 m²/min |
| | | | | | | | C | A |
| Example 7 | 42° C. | PE | 200 μm | 200 mm | 30 m | Melting | 88% | 5 m²/min |
| | | | | | | | B | A |
| Example 8 | 42° C. | PE | 100 μm | 50 mm | 50 mm | Melting | 90% | 5 m²/min |
| | | | | | | | A | A |
| Comparative | 42° C. | PE | 100 μm | 200 mm | 30 m | Solution | 92% | 4 m²/min |
| Example 1 | | | | | | | A | A |
| Comparative | 42° C. | SiO₂ Wafer x | 100 μm | 10 μm | 10 μm | Solution | | 10⁻¹⁰ m²/min |
| Example 2 | | | | | | | | B |

Details of the abbreviations in Table 1 are as follows.

PLLA: Polylactic acid (TERRAMAC TP-4000 manufactured by UNITIKA LTD.)

PVC: Polyvinyl chloride (TK-1000 manufactured by Shin-Etsu Chemical Co., Ltd.)

PC: Polycarbonate (CALIBRE 301-10 manufactured by SUMIKA POLYCARBONATE LTD.)

PVA: Polyvinyl alcohol (CP-1220T10 manufactured by Kuraray Co., Ltd.)

Water-soluble Polyester:

PE: Low density polyethylene (NOVATEC LJ802 manufactured by JAPAN POLYETHYLENE CORPORATION)

PET: Polyethylene terephthalate (TK3 manufactured by Bell Polyester Products, Inc.)

SiO₂ Wafer: High purity silicon wafer for research manufactured by AS ONE Corporation

### Comparative Example 3

Melt laminated film formation was performed in the same manner as in Example 1, except that the co-extrusion amount was adjusted such that the layer A had a thickness of 3 nm.

In the obtained laminated film, the layer A was not formed as a uniform film, perforation or breakage occurred, and film formation was impossible.

The polymer films obtained from the laminated films according to Examples 1 to 8 and the polymer film described in Example 9 were all excellent in adhesiveness and were small in the amount of the organic solvent released. Therefore, these were excellent in bioapplicability.

The laminated films according to Examples 1 to 8 were excellent in productivity.

The laminated film according to Comparative Example 1 had a large organic solvent content, and thus the amount of the organic solvent released was large, and the polymer film obtained from the laminated film was poor in bioapplicability.

Regarding the laminated film according to Comparative Example 2, the number of steps required for manufacturing was large, and thus productivity was poor.

In the laminated film according to Comparative Example 3, the layer A could not be formed since the set thickness of the layer A was too small.

The disclosure of JP2017-066078, filed on Mar. 29, 2017, is incorporated herein by reference in its entirety.

All the documents, patent applications, and technical standards described in the present specification are incorporated herein by reference to the same extent as if each individual document, patent application, or technical standard were specifically and individually indicated to be incorporated by reference.

What is claimed is:

1. A laminated film comprising, in order:
a layer containing a thermoplastic polymer A with a thickness of 5 nm to 1,000 nm;
a layer containing a water-soluble thermoplastic polymer B; and
a layer containing a thermoplastic polymer C, the layers being adjacent to each other,
wherein the layer containing the thermoplastic polymer A contains no organic solvent, or an organic solvent content in the layer containing the thermoplastic polymer A is greater than 0 mass % and less than 0.01 mass % with respect to a total mass of the layer containing the thermoplastic polymer A.

2. The laminated film according to claim 1,
wherein a difference between glass transition temperatures of the thermoplastic polymer A and the thermoplastic polymer B is 20° C. or less.

3. The laminated film according to claim 1,
wherein thickness uniformity of the layer containing the thermoplastic polymer A in a width direction and in a longitudinal direction of the laminated film is within a range of ±15%.

4. The laminated film according to claim 1,
wherein the thermoplastic polymer A includes at least one type of resin selected from the group consisting of a polylactic acid, a poly(lactide-co-glycolide) copolymer, polycaprolactone, polyethylene, polypropylene, polyethylene terephthalate, polyvinyl chloride, and polycarbonate.

5. A polymer film which is obtained by water-treating the laminated film according to claim 1, the film comprising:
the layer containing the thermoplastic polymer A.

6. A polymer film which is obtained by water-treating the laminated film according to claim 2, the film comprising:
the layer containing the thermoplastic polymer A.

7. A polymer film which is obtained by water-treating the laminated film according to claim 3, the film comprising:
the layer containing the thermoplastic polymer A.

8. A polymer film which is obtained by water-treating the laminated film according to claim 4, the film comprising:
the layer containing the thermoplastic polymer A.

9. A roll comprising:
the laminated film according to claim 1, which is wound into a roll of 200 mm or greater in width×10 m or greater in length.

10. A roll comprising:
the laminated film according to claim 2, which is wound into a roll of 200 mm or greater in width×10 m or greater in length.

11. A roll comprising:
the laminated film according to claim 3, which is wound into a roll of 200 mm or greater in width×10 m or greater in length.

12. A roll comprising:
the laminated film according to claim 4, which is wound into a roll of 200 mm or greater in width×10 m or greater in length.

13. A method of manufacturing a laminated film, the method comprising:
a step of melt co-extruding a layer containing a thermoplastic polymer A with a thickness of 5 nm to 1,000 nm, a layer containing a water-soluble thermoplastic polymer B, and a layer containing a thermoplastic polymer C so as to laminate the layers in order,
wherein the layer containing the thermoplastic polymer A contains no organic solvent, or an organic solvent content in the layer containing the thermoplastic polymer A is greater than 0 mass % and less than 0.01 mass % with respect to a total mass of the layer containing the thermoplastic polymer A.

14. A method of manufacturing a polymer film, the method comprising:
a step of water-treating the laminated film according to claim 1.

15. A method of manufacturing a polymer film, the method comprising:
a step of water-treating the laminated film according to claim 2.

16. A method of manufacturing a polymer film, the method comprising:
a step of water-treating the laminated film according to claim 3.

17. A method of manufacturing a polymer film, the method comprising:
a step of water-treating the laminated film according to claim 4.
